(19) United States
(12) Patent Application Publication
(10) Pub. No.: US 2026/0050399 A1
(43) Pub. Date: Feb. 19, 2026

(54) MEMORY CONTROLLER, METHOD FOR OPERATING THE SAME, AND STORAGE DEVICE

(71) Applicant: SAMSUNG ELECTRONICS CO., LTD., Suwon-si (KR)

(72) Inventors: Jin Woo HONG, Suwon-si (KR); Chan Ha KIM, Suwon-si (KR); Jun Chul CHOI, Suwon-si (KR); Seok Young KO, Suwon-si (KR); Sung-Hwan BAE, Suwon-si (KR); Ju-Young LEE, Suwon-si (KR)

(21) Appl. No.: 19/097,739

(22) Filed: Apr. 1, 2025

(30) Foreign Application Priority Data
Aug. 16, 2024 (KR) 10-2024-0109710

(51) Int. Cl. G06F 3/06

(52) U.S. Cl. CPC G06F 3/0659; G06F 3/0613; G06F 3/064; G06F 3/0679

(57) ABSTRACT

A memory controller comprises a processing circuit configured to control a non-volatile memory to write data to sub-blocks included in a first super-block in a parallel manner to each other, in response to a first write command from a host, an indexer configured to assign respectively different indices from 1 to n to sub-blocks included in each of a plurality of memory blocks of the non-volatile memory based on a characteristic parameter, in response to a stripe request from the processing circuit, in which n is a natural number greater than or equal to 2, and a super-block constructor configured to select one sub-block from each of the plurality of memory blocks and assemble a first selected sub-blocks so that the first selected sub-blocks have at least indices from 1 to n.

### CROSS-REFERENCE TO RELATED APPLICATION

This application claims priority to Korean Patent Application No. 10-2024-0109710 filed in the Korean Intellectual Property Office on August 16, 2024,, the contents of which are herein incorporated by reference in its entirety.

### BACKGROUND

In a storage device including a non-volatile memory, such as a solid state drive (SSD), data is written in on a super block basis for parallel data processing. The super-block may be constructed by selecting a memory block one by one from a memory chip or a memory die that constitutes the non-volatile memory of the storage device and bundling the selected memory blocks with each other. The data may be written to the memory blocks included in the super-block in a parallel manner with each other at the same time. When the storage device performs a write operation, the storage device should perform the write operation of the data only into the memory block in a write order specified in the memory block. However, a plurality of word-lines that constitute the memory block may have different program times tPROG depending on various factors, thereby reducing consistency of a write throughput.

As the storage device has developed, concept of sub-blocks into which the memory block is subdivided has been introduced, and data may be written and erased in a sub-block basis. Therefore, in constructing the super-block, it is no longer necessary to bundle the memory blocks with each other, and the sub-blocks may be bundled with each other.

### SUMMARY

In general, the present disclosure is directed toward a memory controller that may improve consistency of a write throughput of a storage device when writing data to a non-volatile memory, and a method for operating a memory controller that may improve consistency of a write throughput of a storage device when writing data to a non-volatile memory, in which a storage device has improved consistency of a write throughput when writing data to a non-volatile memory.

According to some implementations, the present disclosure is directed to a memory controller that comprises a processing circuit configured to control a non-volatile memory to write data to sub-blocks included in a first super-block in a parallel manner to each other, in response to a first write command from a host, an indexer configured to assign respectively different indices from 1 to n to sub-blocks included in each of a plurality of memory blocks of the non-volatile memory based on a characteristic parameter, in response to a stripe request from the processing circuit, wherein n is a natural number greater than or equal to 2, and a super-block constructor configured to select one sub-block from each of the plurality of memory blocks and to assemble the selected sub-blocks to construct the first super-block, wherein the super-block constructor is configured to select one sub-block from each of the plurality of memory blocks and assemble a first selected sub-blocks so that the first selected sub-blocks have at least indices from 1 to n.

According to some implementations, the present disclosure is directed to a method for operating a memory controller, the method comprises receiving a first write command from a host, assigning respectively different indices from 1 to n to sub-blocks included in each of a plurality of memory blocks of a non-volatile memory, wherein n is a natural number greater than or equal to 2, selecting one sub-block from each of the plurality of memory blocks and assembling a first selected sub-blocks to construct a first super-block, and writing data to sub-blocks included in the first super-block in a parallel manner to each other, wherein the first selected sub-blocks have at least indices from 1 to n.

According to some implementations, the present disclosure is directed to a storage device that comprises a non-volatile memory including a plurality of memory blocks respectively included in different memory dies, and a memory controller configured to write data to the non-volatile memory, wherein each of the plurality of memory blocks includes n sub-blocks, wherein n is a natural number greater than or equal to 2, wherein the memory controller is configured to assign respectively different indices from 1 to n to the n sub-blocks included in each of the plurality of memory blocks, based on a characteristic parameter, select one sub-block from each of the plurality of memory blocks and to assemble a first selected sub-blocks to construct a first super-block, write data to sub-blocks included in the first super-block in a parallel manner to each other, wherein the first selected sub-blocks have at least indices from 1 to n.

### BRIEF DESCRIPTION OF DRAWINGS

Example implementation will be more clearly understood from the following detailed description, taken in conjunction with the accompanying drawings.

FIG. 1 is a block diagram illustrating an example of a storage device according to some implementations.

FIG. 2 is a block diagram illustrating an example of a non-volatile memory device according to some implementations.

FIG. 3 is a diagram for illustrating an example of a memory block included in the memory cell array of FIG. 2 according to some implementations.

FIGS. 4 and 5 are a diagram illustrating a super-block.

FIG. 6 is a flowchart illustrating an example of a method for operating a memory controller according to some implementations.

FIG. 7 is a block diagram illustrating an example of a method for operating a memory controller according to some implementations.

FIG. 8 is a diagram illustrating an example of a method of assigning an index according to some implementations.

FIG. 9 is a diagram illustrating an example of a method of assigning indices according to some implementations.

FIG. 10 is a diagram illustrating an example of a method of constructing a super-block according to some implementations.

FIG. 11 is a block diagram illustrating an example of a host-storage system including a storage device according to some implementations.

FIG. 12 is a block diagram illustrating an example of a system to which the storage device is applied according to some implementations.

### DETAILED DESCRIPTION

Hereinafter, example implementation will be explained in detail with reference to the accompanying drawings.

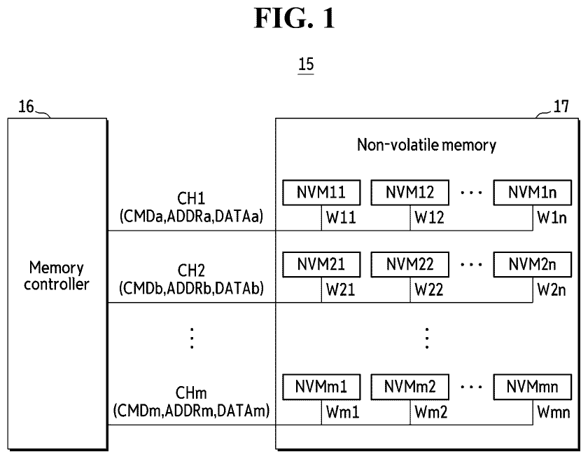

FIG. 1 is a block diagram illustrating an example of a storage device according to some implementations. In FIG. 1, a storage device 15 may include a non-volatile memory 17 and a memory controller 16. The storage device 15 may be embodied as various types of storage devices, such as a solid-state drive (SSD), an embedded MultiMedia Card (eMMC), a universal flash storage (UFS), or a compact flash (CF), a secure digital (SD), a micro-SD (Micro Secure Digital), a mini-SD (Mini Secure Digital), an extreme digital (xD), or a memory stick.

The storage device 15 may support a plurality of channels CH1 to CHm, and the non-volatile memory 17 and the memory controller 16 may be connected to each other via the plurality of channels CH1 to CHm.

The non-volatile memory 17 may include non-volatile memory devices NVM11 to NVMmn. Each of the non-volatile memory devices NVM11 to NVMmn may be connected to one of the plurality of channels CH1 to CHm via a corresponding way. For example, the non-volatile memory devices NVM11 to NVM1n may be connected to the first channel CH1 via corresponding ways W11 to W1n, respectively. The non-volatile memory devices NVM21 to NVM2n may be connected to the second channel CH2 via corresponding ways W21 to W2n, respectively. Each of the non-volatile memory devices NVM11 to NVMmn may be embodied as any memory unit that may operate according to an individual command from the memory controller 16. For example, each of the non-volatile memory devices NVM11 to NVMmn may be embodied as a chip or a die. However, the present disclosure is not limited thereto.

The memory controller 16 may be configured to transmit and receive signals to and from the non-volatile memory 17 via the plurality of channels CH1 to CHm. For example, the memory controller 16 may be configured to transmit commands CMDa to CMDm, addresses ADDRa to ADDRm, and data DATAa to DATAm to the non-volatile memory 17 via the channels CH1 to CHm, or to receive the data DATAa to DATAm from the non-volatile memory 17 via the channels CH1 to CHm.

The memory controller 16 may be configured to select one of the non-volatile memory devices NVM11 to NVMmn connected to each corresponding channel via each corresponding channel, and to transmit and receive signals to and from the selected non-volatile memory device via each corresponding channel. For example, the memory controller 16 may be configured to select the non-volatile memory device NVM11 from among the non-volatile memory devices NVM11 to NVM1n connected to the first channel CH1 via the first channel CH1. The memory controller 16 may be configured to transmit the command CMDa, the address ADDRa, and the data DATAa to the selected non-volatile memory device NVM11 via the first channel CH1, or may receive the data DATAa from the selected non-volatile memory device NVM11 via the first channel CH1.

The memory controller 16 may be configured to transmit and receive signals to and from the non-volatile memory 17 in a parallel manner via different channels. For example, the memory controller 16 may be configured to transmit the command CMDb to the non-volatile memory 17 via the second channel CH2 while transmitting the command CMDa to the non-volatile memory 17 via the first channel CH1. For example, the memory controller 16 may be configured to receive the data DATAb from the non-volatile memory 17 via the second channel CH2 while receiving the data DATAa from the non-volatile memory 17 via the first channel CH1.

The memory controller 16 may be configured to control overall operations of the non-volatile memory 17. The memory controller 16 may be configured to transmit a signal to the channels CH1 to CHm to control each of the non-volatile memory devices NVM11 to NVMmn connected to the channels CH1 to CHm. For example, the memory controller 16 may be configured to transmit the command CMDa and the address ADDRa to the first channel CH1 to control a selected one of the non-volatile memory devices NVM11 to NVM1n.

Each of the non-volatile memory devices NVM11 to NVMmn may operate under control of the memory controller 16. For example, the non-volatile memory device NVM11 may program the data DATAa based on the command CMDa, the address ADDRa, and the data DATAa provided to the first channel CH1. For example, the non-volatile memory device NVM21 may read-out the data DATAb based on the command CMDb and the address ADDRb provided to the second channel CH2, and transmit the read-out data DATAb to the memory controller 16.

In FIG. 1, the non-volatile memory 17 communicates with the memory controller 16 via the m channels CH1 to CHm, and the non-volatile memory 17 includes the n non-volatile memory devices corresponding to each of the m channels. However, the number of channels and the number of non-volatile memory devices connected to one channel may vary.

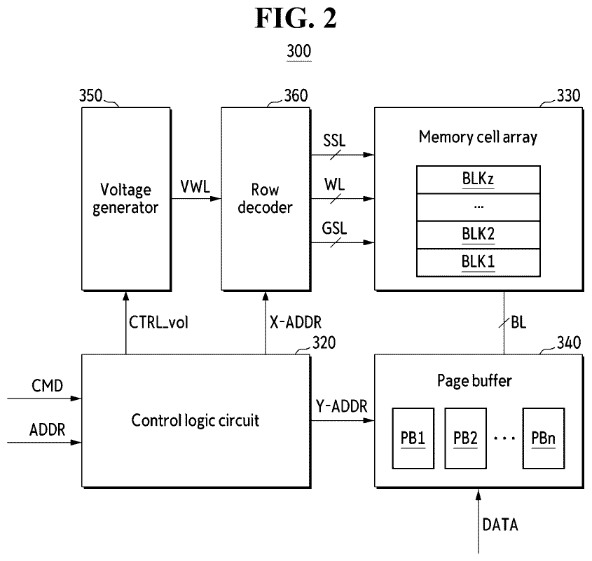

FIG. 2 is a block diagram illustrating an example of a non-volatile memory device according to some implementations. In FIG. 2, a non-volatile memory device 300 may include a memory cell array 330, a voltage generator 350, a row decoder 360, a page buffer 340, and a control logic circuit 320. The non-volatile memory device 300 may be any one of the non-volatile memory devices NVM11 to NVMmn of FIG. 1.

The control logic circuit 320 may be configured to receive a command CMD and an address ADDR, and to generate a control signal CTRL_vol for controlling the voltage generator 350 and a control signal for controlling the page buffer 340, and to generate a row address X_ADDR and a column address Y_ADDR based on the address ADDR. The control logic circuit 320 may be configured to output the row address X_ADDR to the row decoder 360, and to output the column address Y_ADDR to the page buffer 340.

The voltage generator 350 may be configured to receive power and regulate a word-line base voltage VWL for a memory operation based on the control signal CTRL_vol from the control logic circuit 320, and to provide the regulated word-line base voltage VWL to the memory cell array 330 via the row decoder 360.

The row decoder 360 may be connected to the memory cell array 400 via a word-line WL, a string select line SSL, and a ground select line GSL. The row decoder 360 may be configured to decode the row address X_ADDR input from the control logic circuit 320 to select at least one of a plurality of memory blocks BLK1 to BLKz. That is, the row decoder 360 may select the word-line WL, the string select line SSL, and the ground select line GSL using the row address X_ADDR. The row decoder 360 may provide the word-line base voltage VWL supplied from the voltage generator 350 to the word-line WL.

The page buffer 340 may be connected to the memory cell array 330 via the bit-line BL. During a write operation, the page buffer 340 may be configured to receive program data DATA provided from the memory controller (16 in FIG. 1), and to store the program data DATA in the memory cell array 330 based on the column address Y_ADDR provided from the control logic circuit 320. During a read operation, the page buffer 340 may provide read data DATA stored in the memory cell array 330 to the memory controller (16 of FIG. 1) based on the column address Y_ADDR provided from the control logic circuit 320.

The control logic circuit 320 may be configured to control overall operations of the non-volatile memory device 300, and to output each control signal related to the memory operation. For example, the control logic circuit 320 may be configured to control the non-volatile memory device 300 using an internal control signal based on at least one of the address ADDR, the command CMD, and the control signal CTRL received from the memory controller (16 of FIG. 1).

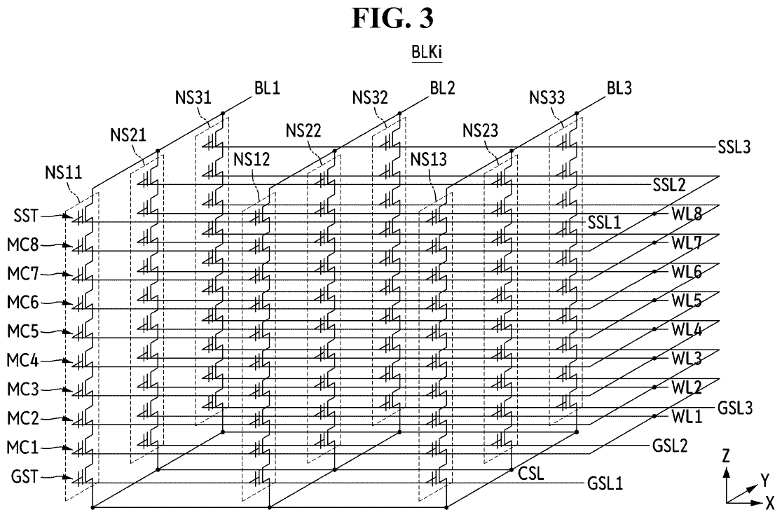

FIG. 3 is a diagram for illustrating an example of a memory block included in the memory cell array of FIG. 2 according to some implementations. In FIG. 3, the memory cell array 330 may include the plurality of memory blocks BLK1 to BLKz. Each of the plurality of memory blocks BLK1 to BLKz may be connected to the row decoder 360 via the word-line WL, the string select line SSL, and the ground select line GSL, and may be connected to the page buffer 340 via the bit-line BL.

In FIG. 3, the memory cell array (330 of FIG. 2) may include a plurality of memory cells respectively disposed in respective areas where the plurality of word-lines WL and the plurality of bit-lines BL intersect each other. Each memory cell may be formed into each of various cell types including SLC (Single Level Cell), MLC (Multi Level Cell), TLC (Triple Level Cell), QLC (Quad Level Cell), etc.

Each of the plurality of memory blocks BLK1 to BLKz may be formed in a three-dimensional structure on a substrate. For example, the i-th memory block BLKi may include a plurality of memory NAND strings NS11 to NS33 connected to and disposed between the plurality of bit-lines BL1 to BL3 and a common source line CSL. Each of the plurality of memory NAND strings NS11 to NS33 may include a string select transistor SST, a plurality of memory cells MC, and a ground select transistor GST. In FIG. 3, it is illustrated that the number of the plurality of bit-lines BL1 to BL3 is three, the number of the plurality of memory NAND strings NS11 to NS33 is nine, and each of the plurality of memory NAND strings NS11 to NS33 includes eight memory cells MC. However, the present disclosure is not necessarily limited thereto, and each of the numbers may vary depending on its implementation.

A gate of the string select transistor SST may be connected to a corresponding one of the string select lines SSL1 to SSL3. Each of the plurality of memory cells MC may be connected to a corresponding one of the word-lines WL1 to WL8. The word-lines WL1 to WL8 may act as gate lines. A gate of the ground select transistor GST may be connected to a corresponding one of the ground select lines GSL1 to GSL3. The string select transistor SST may be connected to a corresponding one of the bit-lines BL1 to BL3, and the ground select transistor GST may be connected to the common source line CSL.

In the i-th memory block BLKi, the memory cells MC of the same vertical level may be connected in common to the same word-line (e.g., WL1). The memory cells MC of the same vertical level may be respectively connected to the ground select lines GSL1 to GSL3 and may be connected respectively to the string select lines SSL1 to SSL3.

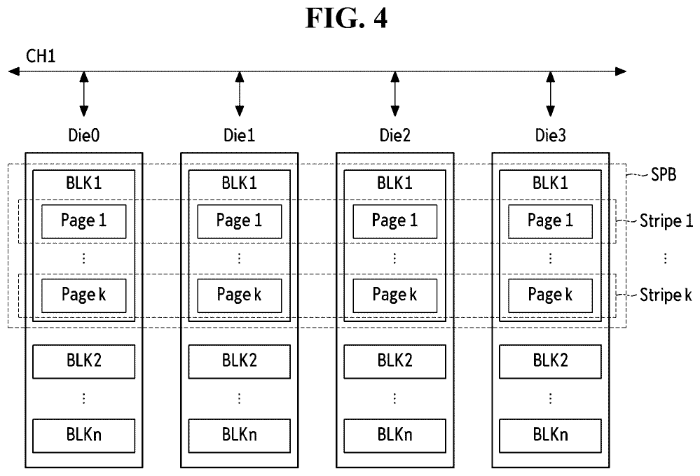

FIG. 4 is a diagram illustrating an example of a super-block according to some implementations. In FIG. 4, memory dies Die0 to Die3 may be commonly connected to the first channel CH1. Each of the memory dies Die0 to Die3 may correspond to the non-volatile memory device 300 of FIG. 2. Each of the memory dies Die0 to Die3 may include a plurality of planes. However, for the convenience of description, the present disclosure assumes that one memory die includes one plane. One plane may include the plurality of memory blocks BLK1 to BLKn (n is a natural number greater than or equal to 1), and one memory block may include a plurality of pages Page 1 to Page k (k is a natural number greater than or equal to 1). The memory controller may be configured to control the memory blocks included in the memory dies Die0 to Die3 commonly connected to one channel on a super-block basis. In other words, the super-block may include at least two or more memory blocks that are respectively included in different memory dies. For example, the first memory blocks BLK1 respectively included in the memory dies Die0 to Die3 may be combined with each other to constitute a first super-block SPB.

One super-block may be composed of a plurality of stripes. One stripe may include a plurality of pages. For example, the respective first pages Page 1 of the plurality of first memory blocks BLK1 included in the first super-block SPB may constitute a first stripe Stripe 1. Therefore, one super-block may include the first stripe Stripe 1 to a k-th stripe Stripe k.

The memory controller may be configured to write data to the memory dies Die0 to Die3 on a stripe basis. The memory controller may be configured to write data to the plurality of first memory blocks BLK1 of the memory dies Die0 to Die3 included in the first super-block SPB in a parallel manner with each other.

When writing data to the memory dies Die0 to Die3 on a stripe basis, the memory controller may be configured to sequentially write data to the first stripe Stripe 1 to the k-th stripe Stripe k in this order. The plurality of pages that constitute one stripe may share the word-line WL. A time required for data to be written to a page is referred to as a program time tPROG. The different word-lines WL may have different program times tPROG due to reasons in terms of a manufacturing process or a progress defect. Therefore, when the memory controller sequentially writes data to the first stripe Stripe 1 to the k-th stripe Stripe k in this order, the program times tPROG to the stripes may be different from each other. As a result, the write throughput of the storage device (15 in FIG. 1) may become inconsistent, which may deteriorate the stability of the operation of the storage device 15. To prevent this problem, when an external device (e.g., a host) intends to write data to the storage device 15, the write performance may be intentionally lowered to level down the average of the write throughput of the storage device 15, thereby leveling out the write throughput of the storage device 15. However, although this scheme may level out the write throughput, it significantly reduces the average value of the write throughput. That is, the performance of the write operation is sacrificed for the stability of the write operation of the storage device 15.

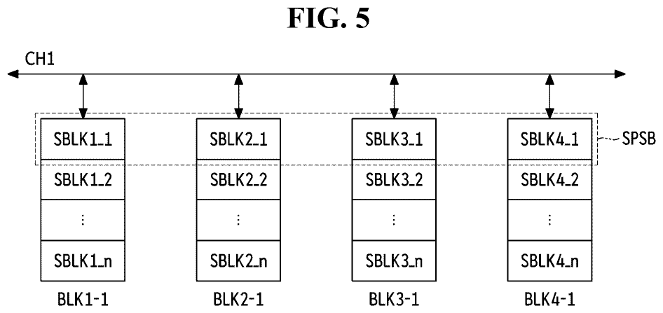

FIG. 5 is a diagram illustrating an example of a sub-block according to some implementations. In FIG. 5, each of first to fourth memory blocks BLK1_1 to BLK4_1 may be one of the plurality of memory blocks respectively included in different memory dies Die0 to Die3. The first to fourth memory blocks BLK1_1 to BLK4_1 may be, for example, memory blocks that share the same word-line. The first memory block BLK1_1 may be divided into n sub-blocks SBLK1_1 to SBLK1_n (n is a natural number greater than or equal to 2). Each of the other memory blocks BLK2_1 to BLK4_1 may be divided in the same manner as in the first memory block BLK1_1. With the advancement of storage device technology, data writing and erasing may be performed in a sub-block basis. For example, the first sub-block SBLK1_1 may include a plurality of pages as the memory block includes. The memory controller may be configured to control the sub-blocks included in the memory dies Die0 to Die3 commonly connected to a single channel on a super-block basis as the memory controller controls the memory blocks included in the memory dies Die0 to Die3 commonly connected to a single channel on a super-block basis. In other words, the super-block may include at least two or more sub-blocks into which each of the memory blocks respectively included in different memory dies is divided. For example, the memory dies Die0 to Die3 may respectively include the first to fourth memory blocks BLK1_1 to BLK4_1. The first sub-blocks SBLK1_1 to SBLK4_1 included in the first to fourth memory blocks BLK1_1 to BLK4_1, respectively may be combined with each other to construct the first super-block SPSB.

In some implementations, when the memory controller constructs the super-block, the memory controller may be configured to construct the super-block by combining the sub-blocks included in the first to fourth memory blocks BLK1_1 to BLK4_1, respectively, with each other in various ways. For example, the memory controller may be configured to construct the super-block by combining the first sub-block SBLK1_1 of the first memory block BLK1_1, the second sub-block SBLK2_2 of the second memory block BLK2_1, the third sub-block SBLK3_3 of the third memory block BLK3_1, and the fourth sub-block SBLK4_4 of the fourth memory block BLK4_1 with each other. In addition, the super-block may be constructed by combining the sub-blocks with each other in various ways.

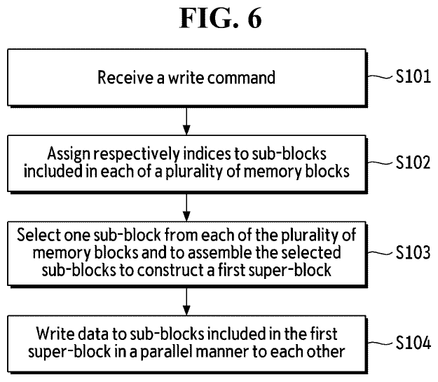

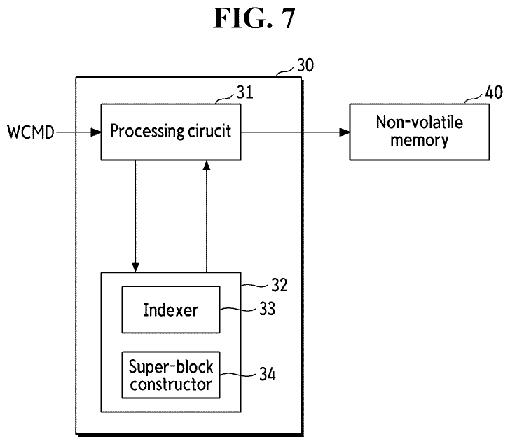

FIG. 6 is a flowchart illustrating an example of a method for operating a memory controller according to some implementations. FIG. 7 is a block diagram illustrating an example of a method for operating a memory controller according to some implementations.

A method for operating a memory controller, which will be described with reference to FIG. 6 and FIG. 7, may include a memory controller 30 that receives a write command in S101. For example, a processing circuit 31 of the memory controller 30 may receive a first write command WCMD from an external element (e.g., a host). The memory controller 30 may correspond to the memory controller (16 of FIG. 1), and the non-volatile memory 40 may correspond to the non-volatile memory (17 of FIG. 1).

The memory controller 30 assigns an index to each of a plurality of sub-blocks of each of the memory blocks in S102. For example, the processing circuit 31 of the memory controller 30 may request a stripe to a write consistency striper 32 in order to write data to the non-volatile memory 40 in response to the first write command. The write consistency striper 32 may include an indexer 33 and a super-block constructor 34. In this regard, each of the write consistency striper 32, the indexer 33, and the super-block constructor 34 may be configured to be embodied using one or a combination of hardware, firmware, and software. For example, the memory controller 30 may further include a memory storing therein firmware for controlling the non-volatile memory 40, and the firmware stored in the memory may be executed by the processing circuit 31, thereby causing the processing circuit 31 to execute the write consistency striper 32, the indexer 33, and the super-block constructor 34. In some implementations, each of the write consistency striper 32, the indexer 33, and the super-block constructor 34 may be configured to be embodied as a separate logic circuit and may be located within the memory controller 30 and within the processing circuit 31.

In response to the above request, the indexer 33 may be configured to respectively assign indices from 1 to n (n is a natural number greater than or equal to 2) to the plurality of sub-blocks included in each of the memory blocks respectively included in the different memory dies to construct the super-block. The index may be determined based on the number of sub-blocks into which one memory block is divided. For example, when one memory block is divided into three sub-blocks, the index may include 1 to 3. The scheme of assigning the index will be described later.

The memory controller 30 selects one sub-block from each of the memory blocks to construct the first super-block in S103. For example, the super-block constructor 34 may be configured to select one sub-block from each of the memory blocks based on the index assigned by the indexer 33 to construct the first super-block. In this regard, the super-block constructor 34 may be configured to select one sub-block from each of the memory blocks so that the sub-blocks belonging to the first super-block have at least indices from 1 to n. In other words, a set of indices of the sub-blocks belonging to the first super-block may include all of indices from 1 to n. The scheme of combining the super-blocks with each other will be described in more detail later.

The memory controller 30 writes data to the plurality of sub-blocks belonging to the first super-block in a parallel manner to each other in S104. For example, the super-block constructor 34 may be configured to construct the first super-block, and to provide the stripe of the plurality of sub-blocks belonging to the first super-block to the processing circuit 31. Accordingly, the processing circuit 31 may write data to the stripes of the plurality of sub-blocks belonging to the first super-block in a parallel manner to each other.

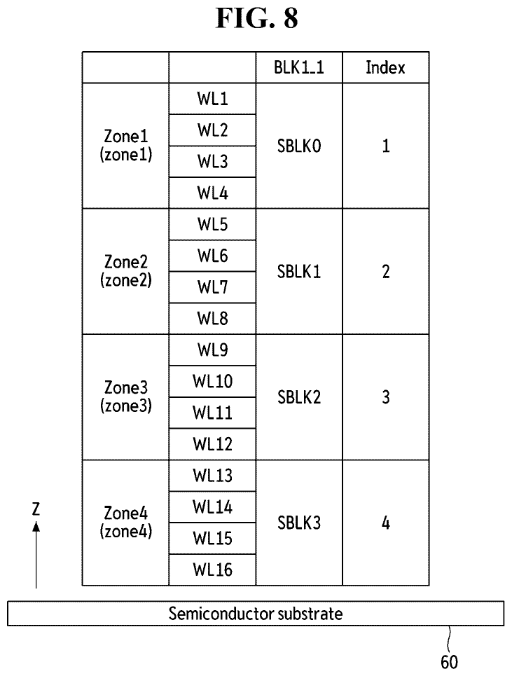

FIG. 8 is a diagram illustrating an example of a method of assigning an index according to some implementations. In FIGS. 7 and 8, operation S102 of assigning an index to a plurality of sub-blocks of each of the memory blocks is described in detail.

According to some implementations, for example, in response to a request from the processing circuit 31, the indexer 33 may be configured to respectively assign indices from 1 to n (n is a natural number greater than or equal to 2) to the plurality of sub-block included in each of the memory blocks respectively included in different memory dies to construct a super-block. In this regard, the indexer 33 may be configured to respectively assign indices from 1 to n (n is a natural number greater than or equal to 2) to the plurality of sub-block included in each of the memory blocks respectively included in different memory dies based on a position of each of the sub-blocks. The first memory block BLK1_1 may include first to fourth sub-blocks SBLK0 to SBLK3. FIG. 8 shows that the first memory block BLK1_1 is divided into four sub-blocks. However, the number of sub-blocks is not limited thereto, and each of the memory blocks may be divided into two or three sub-blocks or at least five sub-blocks. When the first memory block BLK1_1 is divided into four sub-blocks, the indices from 1 to 4 may be assigned thereto, respectively. In the same manner as in FIG. 8, the indices may be respectively assigned to the sub-blocks of each of the memory blocks respectively included in different memory dies in addition to the first memory block BLK1_1.

The non-volatile memory has a structure in which a plurality of memory cells are stacked on a semiconductor substrate 60 in a direction Z perpendicular to the semiconductor substrate 60. The first memory block BLK1_1 may be divided into the first to fourth sub-blocks SBLK0 to SBLK3 arranged in the direction Z perpendicular to the semiconductor substrate 60.

It is assumed that a position to which the word-lines WL1 to WL4 belong is a first zone zone1, a position to which the word-lines WL5 to WL8 belong is a second zone zone2, a position to which the word-lines WL9 to WL12 belong is a third zone zone3, and a position to which the word-lines WL13 to WL16 belong is a fourth zone zone4. The zones may be distinguished from each other based on a distance in the direction Z perpendicular to the semiconductor substrate 60 from the semiconductor substrate 60.

The plurality of word-lines WL1 to WL4 included in the first sub-block SBLK0 may be further away from the semiconductor substrate 60 in the vertical direction Z than the plurality of word-lines WL5 to WL8 included in the second sub-block SBLK1 may be. The plurality of word-lines WL5 to WL8 included in the second sub-block SBLK1 may be further away from the semiconductor substrate 60 in the vertical direction Z than the plurality of word-lines WL9 to WL12 included in the third sub-block SBLK2 may be. The plurality of word-lines WL9 to WL12 included in the third sub-block SBLK2 may be further away from the semiconductor substrate 60 in the vertical direction Z than the plurality of word-lines WL13 to WL16 included in the fourth sub-block SBLK3 may be.

That is, the distance in the direction Z perpendicular to the semiconductor substrate 60 between each of the first sub-block SBLK0, the second sub-block SBLK1, the third sub-block SBLK2, and the fourth sub-block SBLK3 and the semiconductor substrate 60 may decrease as the non-volatile memory extends in a direction from the first sub-block SBLK0, to the second sub-block SBLK1, to the third sub-block SBLK2, to the fourth sub-block SBLK3. The indexer 33 may be configured to assign the indices in an ascending order to the first sub-block SBLK0, the second sub-block SBLK1, the third sub-block SBLK2, and the fourth sub-block SBLK3 arranged in an order in which the distance thereof in the direction Z from the semiconductor substrate 60 decreases.

The indexer 33 may be configured to assign an index ‘1’ to the first sub-block SBLK0 belonging to the first zone zone1 with the largest distance in the direction Z from the semiconductor substrate 60. The indexer 33 may be configured to assign an index ‘2’ to the second sub-block SBLK1 belonging to the second zone zone2. The indexer 33 may be configured to assign an index ‘3’ to the third sub-block SBLK2 belonging to the third zone zone3. The indexer 33 may be configured to assign an index ‘4’ to the fourth sub-block SBLK3 belonging to the fourth zone zone4 with the smallest distance in the direction Z from the semiconductor substrate 60. In the same manner, the indices 1 to 4 may also be respectively assigned to the plurality of sub-blocks included in each of the memory blocks BLK2_1 to BLK4_1 respectively included in different memory dies based on a corresponding zone (zone1 to zone4).

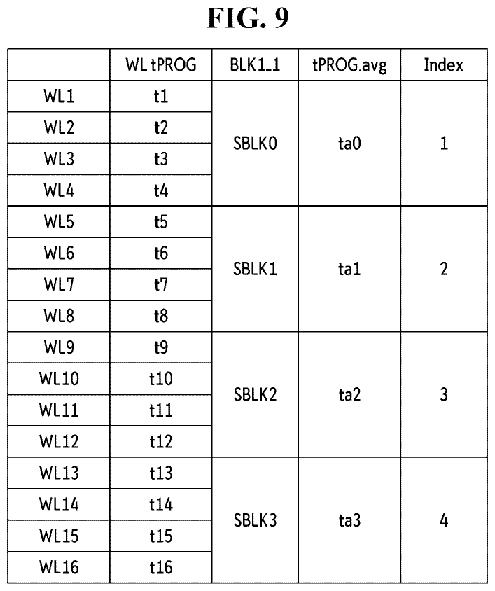

FIG. 9 is a diagram illustrating an example of a method of assigning indices according to some implementations. In FIGS. 7 and 9, operation S102 of assigning indices to a plurality of sub-blocks of each of the memory blocks is described in detail.

According to some implementations, for example, the indexer 33 may be configured to respectively assign indices from 1 to n (n is a natural number greater than or equal to 2) to the plurality of sub-block included in each of the memory blocks respectively included in different memory dies in response to a request from the processing circuit 31 to construct a super-block. In this regard, the indexer 33 may be configured to respectively assign indices from 1 to n (n is a natural number greater than or equal to 2) to the plurality of sub-block included in each of the memory blocks included in a different memory die, based on program time information about each of the sub-blocks. The first memory block BLK1_1 may include the first to fourth sub-blocks SBLK0 to SBLK3. FIG. 8 shows that the first memory block BLK1_1 is divided into four sub-blocks. However, the number of sub-blocks is not limited thereto, and each of the memory blocks may be divided into two or three sub-blocks or at least five sub-blocks. When the first memory block BLK1_1 is divided into four sub-blocks, the indices from 1 to 4 may be assigned thereto, respectively. In the same manner as in FIG. 9, the indices may be respectively assigned to the sub-blocks of each of the memory blocks respectively included in different memory dies in addition to the first memory block BLK1_1.

As described above, the time required for data to be written to a page is referred to as the program time tPROG. The different word-lines WL may have different program times tPROG due to reasons in terms of a manufacturing process or a progress defect. For example, the program times of the word-lines WL1 to WL16 included in the first memory block BLK1_1 may be slightly different from each other.

The firmware that controls the operation of the memory controller (for example, the processing circuit may be configured to execute the firmware and control the non-volatile memory according to the firmware's command.) may include a plurality of instructions, and the plurality of instructions may include a characteristic parameter. The characteristic parameter may include information about various characteristics of the non-volatile memory. The characteristic parameter may include, for example, information such as a value WL tPROG of the program time tPROG of each of the word-lines included in the non-volatile memory, an average value tPROG. avg of the program times tPROG of the plurality of word-lines included in each of the sub-blocks, a deviation of the program times tPROG of the plurality of word-lines included in each of the sub-blocks, the maximum and minimum values of the program times tPROG of the plurality of word-lines included in each of the sub-blocks, etc. The indexer 33 may be configured to obtain information about the program time tPROG of each of the sub-blocks from the characteristic parameter. The characteristic parameter may be determined during a test before shipment of the storage device and may be updated by the memory controller during the use of the storage device.

The indexer 33 may be configured to respectively assign indices from 1 to n (n is a natural number greater than or equal to 2) to the sub-blocks based on information about the program times tPROG of the sub-blocks. For example, the indices from 1 to 4 may be respectively assigned to the first to fourth sub-blocks SBLK0 to SBLK3 included in the first memory block BLK1_1, based on the average values ta1 to ta4 of the program times tPROG of the plurality of word-lines included in the first to fourth sub-blocks. When the average value ta1 of the program times tPROG of the plurality of word-lines WL1 to WL4 included in the first sub-block SBLK0 is the smallest, the index ‘1’ may be assigned to the first sub-block SBLK0. When the average value ta2 of the program times tPROG of the plurality of word-lines WL5 to WL8 included in the second sub-block SBLK1 is the next smallest, the index ‘2’ may be assigned to the second sub-block SBLK1. When the average value ta3 of the program times tPROG of the plurality of word-lines WL9 to WL12 included in the third sub-block SBLK2 is the next smallest to the average value ta2, the index ‘3’ may be assigned to the third sub-block SBLK2. Finally, the average value ta4 of the program times tPROG of the plurality of word-lines WL13 to WL16 included in the remaining fourth sub-block SBLK3 is the largest, such that the index ‘4’ may be assigned to the fourth sub-block SBLK3. In the same manner, the indices from 1 to 4 may be respectively assigned to a plurality of sub-blocks included in each of the memory blocks BLK2_1 to BLK4_1 respectively included in different memory dies, based on the program time information of each of the sub-blocks.

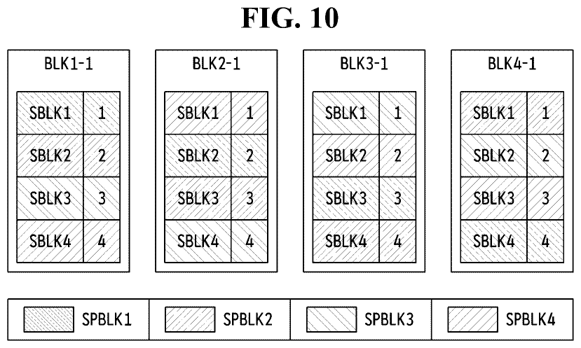

FIG. 10 is a diagram illustrating an example of a method of constructing a super-block according to some implementations. In FIGS. 7 and 10, a method of selecting one sub-block from each of the memory blocks and combining the selected sub-blocks with each other to construct a first super-block in S103 is described in detail.

According to some implementations, the super-block constructor 34 may be configured to select one sub-block from each of the memory blocks based on the index assigned by the indexer 33 and combine the selected sub-blocks with each other to construct the first super-block. In this regard, the super-block constructor 34 may be configured to select one sub-block from each of the memory blocks and combine the selected sub-blocks with each other so that the different sub-blocks belonging to the first super-block respectively have the different indices from 1 to n. For example, among the memory blocks BLK1_1 to BLK4_1 respectively included in different memory dies, the super-block constructor 34 may be configured to select the first sub-block SBLK1 having the index ‘1’ from the first memory block BLK1_1, to select the second sub-block SBLK2 having the index ‘2’ from the second memory block BLK2_1, to select the third sub-block SBLK3 having the index ‘3’ from the third memory block BLK3_1, and the to select the fourth sub-block SBLK4 having the index ‘4’ from the fourth memory block BLK4_1 and to combine the selected sub-blocks with each other to construct the first super-block SPBLK1.

The different sub-blocks included in the first super-block SPBLK1 may respectively have the different indices from 1 to 4 assigned by the memory controller. In other words, the set of indices of the sub-blocks belonging to the first super-block SPBLK1 may include all of the different indices from 1 to 4. Similarly, the different sub-blocks included in each of the second to fourth super-blocks SPBLK2 to SPBLK4 may be constructed to respectively have the different indices from 1 to 4 assigned by the memory controller. For example, among the memory blocks BLK1_1 to BLK4_1 respectively included in different memory dies, the super-block constructor 34 may be configured to select the second sub-block SBLK2 that is not included in the first super-block SPBLK1 and has an index of ‘2’ from the first memory block BLK1_1, to select the third sub-block SBLK3 that is not included in the first super-block SPBLK1 and has an index of ‘3’ from the second memory block BLK2_1, to select the fourth sub-block SBLK4 that is not included in the first super-block SPBLK1 and has an index of ‘4’ from the third memory block BLK3_1, and to select the first sub-block SBLK1 that is not included in the first super-block SPBLK1 and has an index of ‘1’ from the fourth memory block BLK4_1, and to combine the selected sub-blocks with each other to construct the second super-block SPBLK2.

As described above, depending on the position of each of the sub-blocks or the average of the program times tPROG of the word-lines included in each of the sub-blocks, the times respectively required for writing data to the sub-blocks may be different from each other. This may cause the write throughput of the storage device (15 in FIG. 1) to become inconsistent.

According to some implementations, the times respectively required for writing data to the sub-blocks having the different indices assigned thereto may be significantly different from each other due to differences between the positions of the sub-blocks or between the averages of the program times tPROG of the word-lines included in the sub-blocks.

When the sub-blocks are respectively selected from the memory blocks so as to respectively have the sequential and different indices assigned by the memory controller 30, and are combined with each other to construct the super-block, the sub-blocks having the times respectively required for writing data to the sub-blocks which are significantly different from each other may constitute a single super-block, so that the times required for writing data to the super-blocks may be uniform.

In some implementations, the super-block constructor 34 may be configured to select the different sub-blocks constituting the single super-block so as to respectively have the different indices assigned by the memory controller 30 to level out the write throughput without intentionally lowering the write performance. That is, the non-volatile memory device, the memory controller, and the storage device that may increase the stability of the write operation of the storage device (15 in FIG. 1) without sacrificing the performance of the write operation.

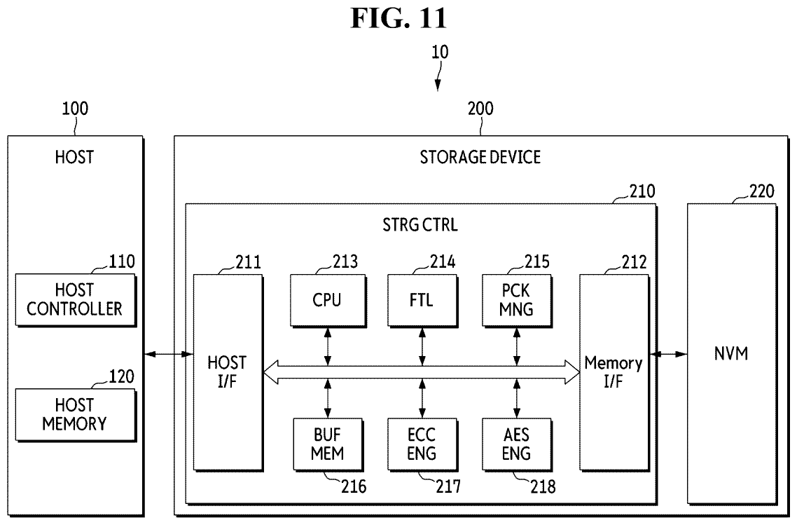

FIG. 11 is a block diagram illustrating an example of a host-storage system including a storage device according to some implementations. In FIG. 11, a host-storage system 10 may include a host 100 and a storage device 200. The storage device 200 may include a storage controller 210 and a non-volatile memory device (NVM) 220. Furthermore, the host 100 may include a host controller 110 and a host memory 120. The host memory 120 may function as a buffer memory for temporarily storing data therein to be transmitted to the storage device 200 or data transmitted from the storage device 200.

The storage device 200 may include a storage medium for storing data therein according to a request from the host 100. For example, the storage device 200 may include at least one of an SSD (Solid State Drive), an embedded memory, and a removable external memory. When the storage device 200 is the SSD, the storage device 200 may be a device complying with the NVMe (non-volatile memory express) standard. When the storage device 200 is the embedded memory or an external memory, the storage device 200 may be a device complying with the UFS (universal flash storage) or eMMC (embedded multi-media card) standard. Each of the host 100 and the storage device 200 may generate a packet according to an adopted standard protocol and transmit the packet.

When the non-volatile memory device 220 of the storage device 200 includes a flash memory, the flash memory may include a 2D NAND memory array or a 3D (or vertical) NAND VNAND memory array. In another example, the storage device 200 may include various other types of non-volatile memories. For example, the storage device 200 may include MRAM (Magnetic RAM), Spin-Transfer Torque MRAM, Conductive bridging RAM (CBRAM), FeRAM (Ferroelectric RAM), PRAM (Phase RAM), Resistive memory (Resistive RAM) and various other types of memories.

The host controller 110 and the host memory 120 may be implemented as separate semiconductor chips. In some implementations, the host controller 110 and the host memory 120 may be integrated into the same semiconductor chip. In an example, the host controller 110 may act as one of a plurality of modules included in an application processor, and the application processor may be implemented as a system on chip (SoC). Further, the host memory 120 may act as an embedded memory provided in the application processor or as a non-volatile memory or a memory module disposed outside the application processor.

The host controller 110 may manage an operation of storing data of a buffer area (e.g., write data) in the non-volatile memory device 220, or storing data of the non-volatile memory device 220 (e.g., read-out data) in the buffer area.

The storage controller 210 may include a host interface 211, a storage-memory interface 212, and a central processing unit (CPU) 213. Furthermore, the storage controller 210 may further include a flash translation layer (FTL) 214, a packet manager 215, a buffer memory 216, an ECC (error correction code) engine 217, and an AES (advanced encryption standard) engine 218.

The storage controller 210 may further include a working memory into which the flash translation layer (FTL) 214 is loaded. An operation of writing or reading data to or from the non-volatile memory device 220 may be controlled by the CPU 213 executing the flash translation layer 214.

Specifically, the storage device 200 may receive a storage device drive signal from the host 100 via the host interface 211. The CPU 213 may transmit an initialization command in response to the storage device drive signal. The initialization command may be transmitted to the non-volatile memory device 220 via the storage-memory interface 212.

The host interface 211 may transmit/receive a packet to/from the host 100. The packet transmitted from the host 100 to the host interface 211 may include a command or data to be written to the non-volatile memory device 220. The packet transmitted from the host interface 211 to the host 100 may include a response to a command or data read from the non-volatile memory device 220. The storage-memory interface 212 may transmit data to be written to the non-volatile memory device 220 to the non-volatile memory device 220 or receive data read from the non-volatile memory device 220. The storage-memory interface 212 may be implemented to comply with a standard protocol such as toggle or ONFI (Open NAND Flash Interface).

The flash translation layer 214 may perform several functions such as address mapping, wear-leveling, and garbage collection. The address mapping operation may refer to an operation of converting a logical address received from the host 100 into a physical address used to actually store data in the non-volatile memory device 220.

The wear-leveling may refer to a scheme to ensure that blocks in the non-volatile memory device 220 are used uniformly to prevent excessive degradation of a specific block. The garbage collection may refer to a scheme of copying valid data of a block to a new block and then erasing the former block to secure available capacity in the non-volatile memory device 220.

The packet manager 215 may generate a packet according to a protocol of an interface with which the packet manager 215 and the host 100 agree, or may parse various information from a packet received from the host 100. Further, the buffer memory 216 may temporarily store therein data to be written to or read from the non-volatile memory device 220.

The buffer memory 216 may be component provided in the storage controller 210, or may be disposed outside the storage controller 210.

The ECC engine 217 may perform an error detection and correction function on read-out data read from the non-volatile memory device 220. More specifically, the ECC engine 217 may generate parity bits for to-be-written data to be written into the non-volatile memory device 220. The generated parity bits together with the to-be-written data may be stored in the non-volatile memory device 220. When reading data from the non-volatile memory device 220, the ECC engine 217 may use the parity bits read from the non-volatile memory device 220 together with the read-out data to correct an error of the read-out data and output the corrected read-out data.

The AES engine 218 may perform at least one of an encryption operation and a decryption operation on data input to the storage controller 210 using a symmetric-key algorithm.

According to some implementations, the storage device 200, the storage controller 210, and the non-volatile memory device 220 may correspond to the storage device (15 in FIG. 1), the memory controller (16 in FIG. 1), and the non-volatile memory (17 in FIG. 1) as described above with refence to FIG. 1 to FIG. 10, respectively.

According to some implementations, the storage controller 210 of the storage device 200 may be configured to receive a first write command from the host 100; assign respectively indices from 1 to n to n sub-blocks included in each of a plurality of memory blocks respectively included in different memory dies of the non-volatile memory device 220, in response to the first write command, wherein n is a natural number greater than or equal to 2; select one sub-block from each of the plurality of memory blocks and combining the selected sub-blocks with each other to construct a first super-block; and write data to the sub-blocks included in the first super-block in a parallel manner to each other. In this regard, the different sub-blocks constituting the first super-block respectively have different indices from 1 to n.

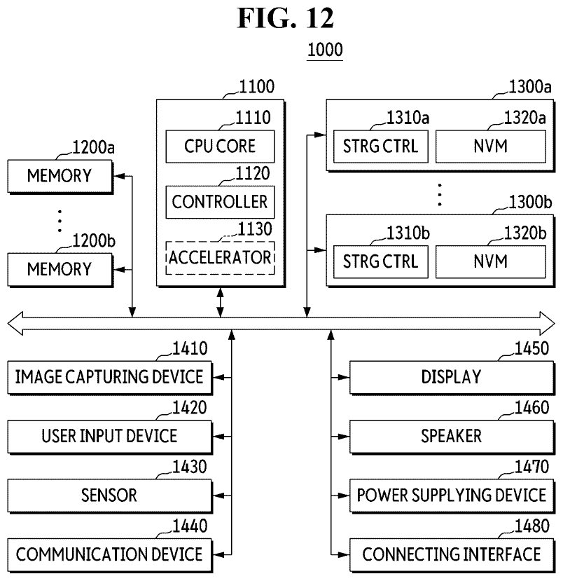

FIG. 12 is a block diagram illustrating an example of a system to which the storage device is applied according to some implementations. In FIG. 12, a system 1000 may be a mobile system, such as a portable communication terminal (e.g., a mobile phone), a smart phone, a tablet PC (personal computer), a wearable device, a healthcare device, an Internet of Things IOT device, etc. However, the system 1000 of FIG. 12 is not necessarily limited to the mobile system but may be a PC, a laptop computer, a server, a media player, or an automobile device (e.g., a navigation device).

In FIG. 12, the system 1000 may include a main processor 1100, a memory (e.g., 1200a and 1200b), and a storage device (e.g., 1300a and 1300b). Furthermore, the system 1000 may include at least one of an image capture device 1410, a user input device 1420, a sensor 1430, a communication device 1440, a display 1450, a speaker 1460, a power supply device 1470, and a connection interface 1480.

The main processor 1100 may be configured to control all operations of the system 1000, more specifically, operations of other components included in the system 1000. The main processor 1100 may be embodied as a general-purpose processor, a dedicated processor, or an application processor.

The main processor 1100 may include at least one CPU core 1110, and may further include a controller 1120 configured to control the memory 1200a and 1200b and/or the storage device 1300a and 1300b. In some embodiments, the main processor 1100 may further include an accelerator 1130 as a dedicated circuit for high-speed data operations such as artificial intelligence (AI) data operations. The accelerator 1130 may include a graphics processing unit (GPU), a neural processing unit (NPU), and/or a data processing unit (DPU), and may be embodied as a chip physically separated from other components of the main processor 1100.

The memory 1200a and 1200b may be used as a main memory device of the system 1000. Each of the memories 1200a and 1200b may include a volatile memory, such as static random access memory (SRAM) and/or dynamic random access memory (DRAM). In some implementations, each of the memories 1200a and 1200b may include non-volatile memory, such as flash memory, phase-changeable RAM (PRAM), and/or resistive RAM (RRAM). The memory 1200a and 1200b and the main processor 1100 may be implemented in the same package.

The storage device 1300a and 1300b may be a non-volatile storage device that stores therein data regardless of whether power is supplied thereto, and may have a larger storage capacity than that of the memory 1200a and 1200b. The storage devices 1300a and 1300b may respectively include storage controllers (STRG CTRL) 1310a and 1310b, and non-volatile memories (NVM) 1320a and 1320b configured to store therein data under control of the storage controllers 1310a and 1310b, respectively. Each of the non-volatile memories 1320a and 1320b may include a flash memory of a 2D (2-dimensional) structure or 3D (3-dimensional) V-NAND (Vertical NAND) structure, or may include other types of non-volatile memories such as PRAM and/or RRAM.

The storage devices 1300a and 1300b may be included in the system 1000 while being physically separated from the main processor 1100. In some implementations, the storage devices 1300a and 1300b and the main processor 1100 may be implemented in the same package. Further, each of the storage devices 1300a and 1300b may be embodied as SSD (solid state device) or a memory card and thus may be detachably coupled to other components of the system 1000 via an interface, such as the connection interface 1480, which will be described later. Each of the storage devices 1300a and 1300b may be a device to which a standard protocol such as UFS (Universal Flash Storage), eMMC (embedded multi-media card), or NVMe (non-volatile memory express) is applied. However, the disclosure is not necessarily limited thereto.

The image capture device 1410 may capture a still image or a moving image, and may include a camera, a camcorder, and/or a webcam.

The user input device 1420 may receive various types of data input from a user of the system 1000, and may be embodied as a touch pad, a keyboard, a mouse, and/or a microphone.

The sensor 1430 may detect various types of physical quantities that may be obtained from an outside out of the system 1000, and may convert the sensed physical quantity into an electrical signal. The sensor 1430 may include a temperature sensor, a pressure sensor, an illumination sensor, a position sensor, an acceleration sensor, a biosensor, and/or a gyroscope sensor.

The communication device 1440 may transmit and receive signals to and from other devices out of the system 1000 according to various communication protocols. The communication device 1440 may be composed of an antenna, a transceiver, and/or a modem.

The display 1450 and the speaker 1460 may function as output devices for outputting visual information and audible information to the user of the system 1000, respectively.

The power supply device 1470 may appropriately convert power supplied from a battery (not shown) built into the system 1000 and/or an external power supply and supply the converted power to each of the components of the system 1000.

The connection interface 1480 may provide a connection between the system 1000 and an external device that is connected to the system 1000 to transmit and receive data to and from the system 1000. The connection interface 1480 may be embodied as various interfaces such as ATA (Advanced Technology Attachment), SATA (Serial ATA), e-SATA (external SATA), SCSI (Small Computer Small Interface), SAS (Serial Attached SCSI), PCI (Peripheral Component Interconnection), PCIe (PCI express), NVMe, IEEE 1394, USB (universal serial bus), SD (secure digital) card, MMC (multi-media card), eMMC, UFS, eUFS (embedded Universal Flash Storage), CF (compact flash) card interface, etc.

According to some implementations, the main processor 1100 may correspond to the host controller 110 of the host 100 as described in FIG. 11. The storage device 1300a and 1300b and the non-volatile memory 1320a and 1320b may correspond to the storage device (15 of FIG. 1) and the non-volatile memory (17 of FIG. 1) as described above with reference to FIG. 1 to FIG. 10.

According to some implementations, the main processor 1100 may provide a write command to the storage device 1300a and 1300b to write data to the non-volatile memory 1320a and 1320b.

According to some implementations, each of the storage devices 1300a and 1300b may be configured to receive a first write command from the main processor 1100; assign respectively indices from 1 to n to n sub-blocks included in each of a plurality of memory blocks respectively included in different memory dies of each of the non-volatile memories 1320a and 1320b, in response to the first write command, wherein n is a natural number greater than or equal to 2; select one sub-block from each of the plurality of memory blocks and combining the selected sub-blocks with each other to construct a first super-block; and write data to the sub-blocks included in the first super-block in a parallel manner to each other. In this regard, the different sub-blocks constituting the first super-block respectively have different indices from 1 to n.

While this disclosure contains many specific implementation details, these should not be construed as limitations on the scope of what may be claimed, equivalents thereof, as well as claims to be described later. Certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a combination can in some cases be excised from the combination, and the combination may be directed to a subcombination or variation of a subcombination.

What is claimed is:

1. A memory controller comprising:
a processing circuit configured to, based on a first write command from a host, control a non-volatile memory to write data to sub-blocks included in a first super-block in a parallel manner to each other;
an indexer configured to, based on a stripe request from the processing circuit, assign respectively different indices from 1 to n to sub-blocks included in each of a plurality of memory blocks of the non-volatile memory based on a characteristic parameter, wherein n is a natural number greater than or equal to 2; and
a super-block constructor configured to:
select one sub-block of the sub-blocks in each of the plurality of memory blocks to obtain selected sub-blocks, and
assemble the selected sub-blocks to construct the first super-block,
wherein the super-block constructor is configured to select one sub-block of the sub-blocks in each of the plurality of memory blocks to assemble first selected sub-blocks having at least indices from 1 to n.

2. The memory controller of claim 1, wherein the indexer is configured to respectively assign the different indices from 1 to n to an n-number of the sub-blocks included in each of the plurality of memory blocks, based on position information of each of the sub-blocks.

3. The memory controller of claim 2,
wherein the non-volatile memory includes a semiconductor substrate, and a plurality of memory cells stacked on the semiconductor substrate in a first direction perpendicular to the semiconductor substrate,
wherein the position information includes a distance in the first direction between each of the sub-blocks and the semiconductor substrate.

4. The memory controller of claim 1, wherein the indexer is configured to respectively assign the different indices from 1 to n to an n-number of the sub-blocks included in each of the plurality of memory blocks, based on program time information of each of the sub-blocks.

5. The memory controller of claim 4, wherein the program time information includes an average of program times of a plurality of word-lines included in each of the sub-blocks.

6. The memory controller of claim 1,
wherein the processing circuit is configured to, based on a second write command from the host, control the non-volatile memory to write data to sub-blocks included in a second super-block in a parallel manner with each other, and
wherein the super-block constructor is configured to select one sub-block not included in the first super-block from each of the plurality of memory blocks and to assemble second selected sub-blocks to construct the second super-block having at least indices from 1 to n.

7. The memory controller of claim 1, wherein the characteristic parameter includes at least one of a program time of each of a plurality of word-lines included in the non-volatile memory, or an average of program times of a plurality of word-lines included in each of the sub-blocks.

8. A method for operating a memory controller, the method comprising:
receiving a first write command from a host;
assigning respectively different indices from 1 to n to sub-blocks included in each of a plurality of memory blocks of a non-volatile memory, wherein n is a natural number greater than or equal to 2;
selecting one sub-block of the sub-blocks in each of the plurality of memory blocks and assembling a first selected sub-blocks to construct a first super-block; and
writing data to sub-blocks included in the first super-block in a parallel manner to each other,
wherein the first selected sub-blocks have at least indices from 1 to n.

9. The method for operating the memory controller of claim 8, wherein assigning respectively different indices from 1 to n to sub-blocks included in each of the plurality of memory blocks includes:
respectively assigning the different indices from 1 to n to an n-number of the sub-blocks included in each of the plurality of memory blocks, based on position information of each of the sub-blocks, wherein n is a natural number greater than or equal to 2.

10. The method for operating the memory controller of claim 9,
wherein the non-volatile memory includes a semiconductor substrate, and a plurality of memory cells stacked on the semiconductor substrate in a first direction perpendicular to the semiconductor substrate, and
wherein the position information includes a distance in the first direction between each of the sub-blocks and the semiconductor substrate.

11. The method for operating the memory controller of claim 8, wherein assigning respectively of the different indices from 1 to n to the sub-blocks included in each of the plurality of memory blocks includes:
respectively assigning the different indices from 1 to n to an n-number of the sub-blocks included in each of the plurality of memory blocks, based on program time information of each of the sub-blocks, wherein n is a natural number greater than or equal to 2.

12. The method for operating the memory controller of claim 11, wherein the program time information includes an average of program times of a plurality of word-lines included in each of the sub-blocks.

13. The method for operating the memory controller of claim 8, further comprising:
receiving a second write command from the host; and
selecting one sub-block not included in the first super-block from each of the plurality of memory blocks and to assemble a second selected sub-blocks to construct a second super-block,
wherein the second selected sub-blocks have at least indices from 1 to n.

14. A storage device comprising:
a non-volatile memory including a plurality of memory blocks respectively included in different memory dies; and
a memory controller configured to write data to the non-volatile memory,
wherein each of the plurality of memory blocks includes an n-number of sub-blocks, wherein n is a natural number greater than or equal to 2,
wherein the memory controller is configured to:
assign, based on a characteristic parameter, respectively different indices from 1 to n to the n-number of sub-blocks included in each memory block of the plurality of memory blocks;
select one sub-block of the n-number of sub-blocks from each of the plurality of memory blocks and assemble a first selected sub-blocks to construct a first super-block; and
write data to sub-blocks included in the first super-block in a parallel manner to each other, and
wherein the first selected sub-blocks have at least indices from 1 to n.

15. The storage device of claim 14, wherein the memory controller is configured to, based on to position information of each of the sub-blocks, assign the indices to each of the sub-blocks included in each of the plurality of memory blocks.

16. The storage device of claim 15,
wherein the non-volatile memory includes a semiconductor substrate, and a plurality of memory cells stacked on the semiconductor substrate in a first direction perpendicular to the semiconductor substrate, and
wherein the position information includes a distance in the first direction between each of the sub-blocks and the semiconductor substrate.

17. The storage device of claim 14, wherein the memory controller is configured to, based on program time information of each of the sub-blocks, respectively assign the indices to each of the sub-blocks included in each of the plurality of memory blocks.

18. The storage device of claim 17, wherein the program time information includes an average of program times of a plurality of word-lines included in each of the sub-blocks.

19. The storage device of claim 14, wherein the memory controller is further configured to:
select one sub-block not included in the first super-block from each of the plurality of memory blocks and to assemble a second selected sub-blocks to construct a second super-block; and
write data to sub-blocks included in the second super-block in a parallel manner to each other,
wherein the second selected sub-blocks have at least indices from 1 to n.

20. The storage device of claim 14, wherein the characteristic parameter includes at least one of a program time of each of a plurality of word-lines included in the non-volatile memory, or an average of program times of a plurality of word-lines included in each of the sub-blocks.
